(19) United States
(12) Patent Application Publication
(10) Pub. No.: US 2013/0291394 A1
(43) Pub. Date: Nov. 7, 2013

(54) Hair Dryer with Touch Screen Control

(71) Applicants: Farouk Shami, Spring, TX (US); Jason Yates, Spring, TX (US)

(72) Inventors: Farouk Shami, Spring, TX (US); Jason Yates, Spring, TX (US)

(21) Appl. No.: 13/463,273

(22) Filed: May 3, 2012

(51) Int. Cl. F26B 19/00; F04D 29/00

(52) U.S. Cl. 34/88; 415/118

(57) ABSTRACT

A hair dryer is provided that includes a touch-sensitive display screen responsive to a computer-based control processor. The control processor is configured with control logic to execute adjustment of dryer operating parameters in response to input received from the touch-sensitive screen, where the operating parameters include at least one of air temperature, air speed and ion content.

### BACKGROUND

1. Field

The present invention relates generally to hair dryers, and, in particular, hair dryers whose parameters may be adjusted with a touch screen display.

2. Description of the Problem and Related Art

Heretofore, hand held hair dryers, particularly those used by hair care and styling professionals, have employed myriad variety of switches and buttons to allow the user to adjust dryer operating parameters according to desired results. Unfortunately, these adjustment solutions only provide either an ‘on/off’ function, or, at best, a set of discrete choices of parameter output, e.g., “low” “medium” or “high,” with respect to parameters such as air speed, temperature, and, lately, ion content.

In addition, the user would need to become very familiar with switch placement and corresponding function in order to efficiently be able to adjust dryer output without drawing attention away from the hair project in question. Then, when a new dryer model is employed, the learning process must be reset.

A dryer is needed that provides greater resolution in parameter adjustment along with a universally understood means of control input.

### SUMMARY

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

A hair dryer is provided below that includes a touch-sensitive display screen that is responsive to a computer-based control processor. The control processor is configured with control logic to execute adjustment of dryer operating parameters in response to input received from the touch-sensitive screen, where the operating parameters include at least one of air temperature, air speed and ion content.

This and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 is a perspective view of an exemplary hair dryer with a touch-sensitive interface screen;

FIG. 2 is a top view of the exemplary hair dryer of FIG. 1;

FIG. 2A is a view of the intake of the hair dryer;

FIG. 3 is an exemplary functional schematic of the components of the hair dryer of FIG. 1; and

FIGS. 4A through 4D are examples of graphic displays that may be used to interface with a control processor for the hair dryer of FIG. 1.

### DETAILED DESCRIPTION

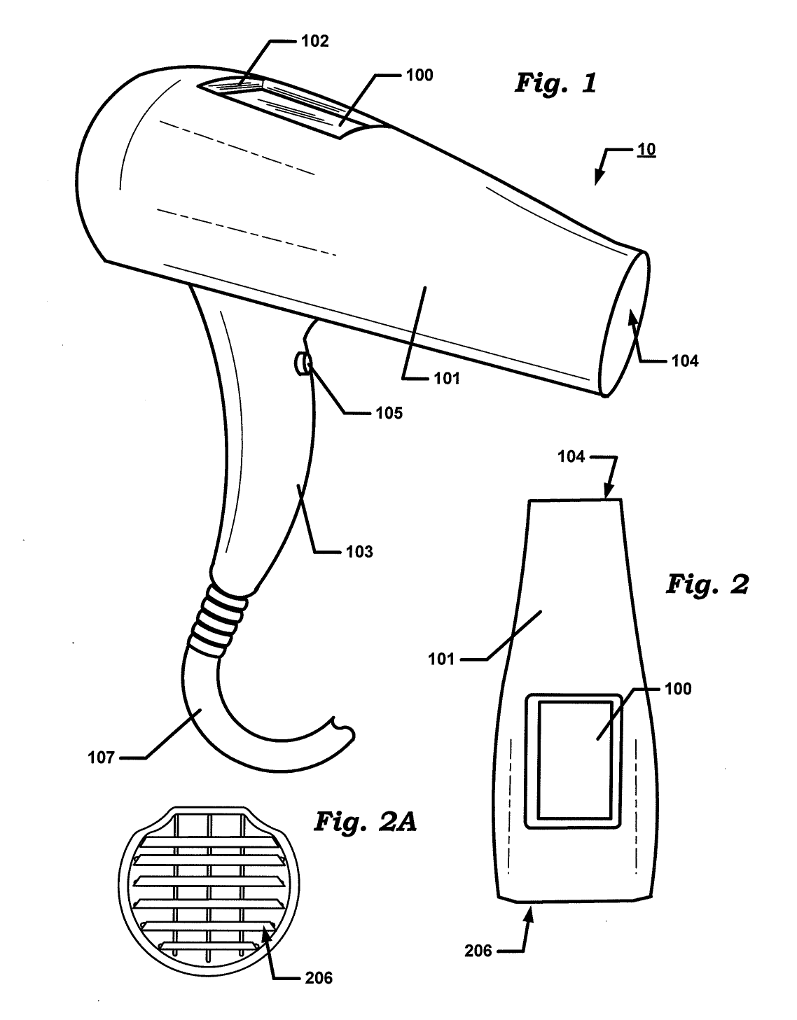

The following detailed description is to be understood with reference to FIGS. 1 through 4D. Elements of the drawings are not necessarily to scale, emphasis instead being placed upon clearly illustrating the principles of the invention. Throughout the drawings, like numerals are used for like and corresponding parts of the various drawings.

This invention may be provided in other specific forms and embodiments without departing from the essential characteristics as described herein. The embodiments described above are to be considered in all aspects as illustrative only and not restrictive in any manner. The following claims rather than the foregoing description indicate the scope of the invention.

An exemplary hair dryer 10 that includes a touch-sensitive interface screen may be similar to that illustrated in FIGS. 1, 2 & 2A, including a generally tubular housing 101 with an intake end 206 through which air is drawn into the dryer, and an outlet nozzle 104 through which air is expelled. The housing 101 is configured with a mounting space 102 suitable for holding a touch-sensitive screen 100 which is an electronic visual display, an example of which is an LCD screen, that is controlled by a computer-based system as discussed in more detail below. The screen may also be any touch-sensitive, electronic visual display screen or surface that can be adapted as an input/output means for user interface with a computer-based system known in the art, or hereafter developed. As used herein, an electronic visual display refers to any computer-based output device for presentation of images transmitted electronically, for visual reception, without producing a permanent record. It will be appreciated that the use of the term “LCD” screen is used for convenience and illustration, and should not be considered to limit the scope of the present invention. In addition, a touch-sensitive screen may be implemented with any technology now used to achieve a touch-enabled electronic visual display and input device, namely, capacitive, resistive, acoustic, infrared, optical and piezoelectric, as well as methods hereafter developed.

A pistol grip handle 103 extends from the bottom of the housing 101 and may include a fitting suitable for a switch, or button 105, for example, an on/off switch or button. The dryer 10 may include a power cord 107 extending from the handle 103, or may be cordless, having a suitable internal battery that is preferably rechargeable.

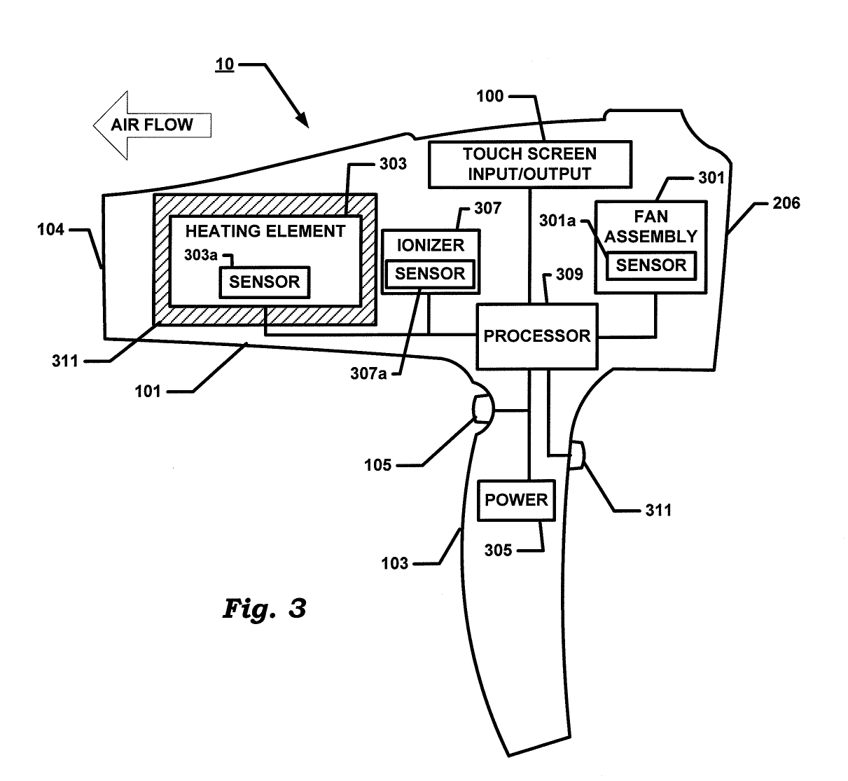

As illustrated in FIG. 3, the housing 101 and the handle 103 define chambers that provide internal support for components of the exemplary dryer 10 and are dimensioned and adapted to provide stable mounting of each component. The dryer 10, thus, includes a conventional motor-driven fan assembly 301 and a heating element 303 which are energized by a power supply 305 connected to the on/off switch 105 and that may receive power from a cord 107 or a battery (not shown) as would be understood by those skilled in the art. The dryer 10 also preferably includes an ion generator 307 for generating ions to be released into the fan-generated air stream and blown onto hair as it is understood that treatment with ions provides benefits in hair care, as described at least in U.S. Pat. No. 6,910,281, to Ito; and U.S. Pat. No. 6,393,718 to Harris, et al.

The exemplary dryer 10 includes a touch-sensitive screen 100 that is mounted in the housing 101 such that a user has access to the screen surface and is in communication with a computer-based processor 309. The processor 309 is also in communication with other components of the dryer 10 in order to provide control of dryer functions and parameters as will be discussed in more detail below. As such, each of the components 301, 303, and 307, include known structures that are responsive to control signals. Additionally, the processor 309 is coupled to the power supply 305. It should be noted that while FIG. 3 shows the processor 309 interposed between the power supply 305 and the remaining components, other configurations for energizing the components are possible without departing from the scope of the present invention. As an additional optional feature, the dryer 10 may include a means, e.g., a button or switch 311, for selectively commanding immediate de-energizing of the heating element while maintaining airflow, thus, expelling relatively colder air.

The processor 309 can be implemented by a field programmable gated array (FPGA), application specific integrated chip (ASIC), a central processing unit (CPU) with a memory, a programmable logic device (PLD), a microcontroller, or other logic device now known or hereafter developed, as would be appreciated by those skilled in the relevant arts.

The processor 309 in effect comprises a computer system. Such a computer system includes, for example, one or more processors that are connected to a communication bus or interface. The computer system can also include a main memory, preferably a random access memory (RAM), and can also include a secondary memory. The secondary memory can include, for example, a hard disk drive and/or a removable storage drive.

The secondary memory can include other similar means for allowing computer programs or other instructions to be loaded into the computer system. Such means can include, for example, a removable storage unit and an interface, a removable memory chip (such as an EPROM, or PROM), and other removable storage units and interfaces which allow software and data to be transferred from the removable storage unit to the computer system.

Computer programs (also called control logic) are stored in the main memory and/or secondary memory. Computer programs can also be received via the communications interface. Such computer programs, when executed, enable the computer system to perform certain features of the present invention as discussed herein. Particularly, the processor 309 is configured with control logic to communicate with the touch-sensitive screen 100, generating control signals to the touch-sensitive screen 100 to render appropriate displays thereon and receiving user input therefrom, as described in more detail below.

Each of the components, i.e., the fan assembly 301, the heating element 303, and the ion generator 307, are configured with sensors to detect rotating speed 301a, temperature 303a, and ion amount 307a, respectively. Each of the sensors 301a, 303a, and 307a, are configured to generate a signal representing measurement of the corresponding parameter and provide such signal to the processor 309. As stated above, the processor 309 is configured with control logic that causes the processor 309 to receive and interpret such signal and execute certain pre-defined functions according to a set of pre-defined criteria in response to such signal and according to commands input by a user via the touch-sensitive screen 100. The processor 309 is also configured to generate control signals to each of the components 301, 303, 307, which are respectively configured to be responsive to such control signals.

The touch-sensitive screen 100 is an input/output device for the processor 309, and, preferably, is a graphic user interface (GUI) using graphic computer-generated icons, text, or a combination thereof to allow adjustment and/or feedback relating to dryer 10 functions. In some embodiments, the touch-sensitive screen may include its own control processor that may be separately configurable to achieve the functions described herein. However, it will be understood that the term “processor” as used herein and its representation in the drawings are intended to incorporate any and all computer-based processors which may be used to achieve features of the described apparatus.

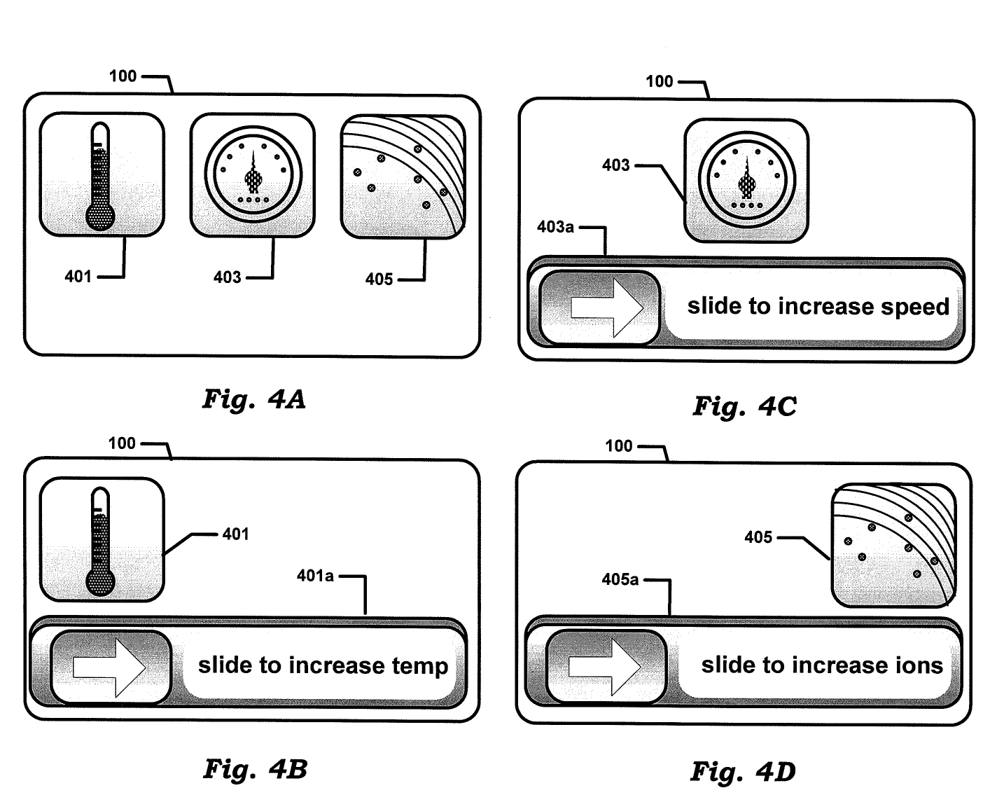

FIGS. 4A through 4D provide exemplary interface screens suitable for interface with an exemplary dryer processor 309, using a touch-sensitive screen 100, as described above. For example, the processor 309 may be configured with control logic to cause the touch-sensitive screen 100 to display graphic icons that represent adjustable operational parameters of the dryer 10, namely, temperature 401, fan speed 403, and ion content 405. Further, FIG. 45A provides an example of a first screen, or page, which may be displayed that present a set of icons corresponding to adjustable parameters 401, 403, 404. The processor 309 may be configured with control logic that, in response to a touch on the screen 100 corresponding to the location of a desired icon 401, 403, 405, the processor 309 renders an appropriate adjustment page, e.g., FIG. 4B (temperature), FIG. 4C (fan speed), or 4D (ion content), through which the user may adjust the selected parameter.

For the purposes of illustration only, assume that the user desires to adjust fan speed. In this configuration, the user would be presented with the first page (FIG. 4A) and select the exemplary fan speed icon 403 which commands the processor 309 to display the fan speed adjustment page (FIG. 4C). The processor 309 may be configured to cause the display of a slide adjustment icon 403a that the user may select and manipulate as desired to adjust the fan speed. It can be seen in this example that each of the parameter adjustment pages (FIGS. 4B, C, & D) include a similar slide adjustment icon 401a, 403a, & 405a, that indicates movement of a slide to change an operating parameter, as illustrated by the arrow button in the Figures. The processor 309 may be configured to respond to the positioning the slide adjustment icon 401a, 403a, or 405a, via the touch-sensitive screen 100, and issue a control signal to the appropriate corresponding component (303, 301, 307), which, in turn, is configured to respond by adjusting output according to the signal.

Regarding spatial arrangement of the components within the housing 101 and the handle 103, it should be noted that it would be preferable to locate the touch-sensitive screen 100 and processor 309 as far from the heating element 303 as possible to avoid degradation of performance. In addition, it is further preferable to enclose the heating element 303 in an insulated compartment 311 to further protect heat-sensitive components in the housing 101.

It can be seen that providing adjustment in this manner allows a user to adjust according to a sliding scale, rather than being forced to choose between a limited number of discrete parameter values. Control structures which may implement such adjustment, and which may be configured to respond to control signals from the processor 309 are known in the art, for example, a variable resistor element, or digitally implemented controls.

As described above and shown in the associated drawings, the present invention comprises a hair dryer with touch screen control. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. A hand-held hair dryer comprising:
a tubular housing having an air intake and an outlet nozzle;
a fan assembly driven by a motor;
a heating element;
a computer-based control processor having a computer-readable memory; and
a touch-sensitive electronic visual display in communication with, and responsive to, said control processor; and
wherein said control processor is configured with control logic for: rendering a display of one or more icons on said touch-sensitive electronic visual display, said icons corresponding to a plurality of operating parameters of said dryer, and for controlling the operating parameters of said dryer, said operating parameters being at least one of heating and fan speed, such that a user may control one of said operating parameters by touching a corresponding icon displayed on said touch-sensitive electronic visual display.

2. The hair dryer of claim 1, wherein said operating parameters are at least one of heating, fan speed, and ion production.

3. The hair dryer of claim 2, wherein said plurality of icons further comprise one or more icons that represent an adjuster corresponding to one or more of said operating parameters, the touching of which adjusts said corresponding parameter.

4. An apparatus for blowing air, said apparatus adapted to operate with one or more operating parameters, said operating parameters being at least one of air speed, air temperature and ion content, said apparatus comprising:
a computer-based control processor; and
a touch-sensitive, electronic interface responsive to said control processor; and
wherein said control processor is configured with control logic to execute adjustment of said one or more operating parameters in response to input received from said interface.

5. The apparatus of claim 4, wherein said interface is configured to display one or more icons, each of said one or more icons corresponding to one of said operating parameters.

6. The apparatus of claim 5, wherein said interface is further configured to display one or more icons that represent an adjuster corresponding to one or more of said operating parameters, the touching of which adjusts said corresponding parameter.
